(19) United States
(12) Patent Application Publication
(10) Pub. No.: US 2019/0061453 A1
(43) Pub. Date: Feb. 28, 2019

(54) VEHICLE CONTROL ARM FOR A WHEEL SUSPENSION

(71) Applicant: FORD GLOBAL TECHNOLOGIES, LLC, Dearborn, MI (US)

(72) Inventors: Eric Leonard BRANGER, Cologne (DE); Fabio MIURA, Cologne (DE)

(73) Assignee: FORD GLOBAL TECHNOLOGIES, LLC, Dearborn, MI (US)

(21) Appl. No.: 16/115,887

(22) Filed: Aug. 29, 2018

(30) Foreign Application Priority Data
Aug. 30, 2017 (DE) 10 2017 215 171.4

(51) Int. Cl. B60G 7/00; B21J 5/02

(52) U.S. Cl. CPC B60G 7/001; B21J 5/02; B60G 2206/16; B60G 2204/41; B60G 2206/14; B60G 2206/8209

(57) ABSTRACT

The disclosure relates to a method for producing a vehicle control arm for a wheel suspension of a motor vehicle. The vehicle control arm is configured from at least one sheet metal part in such a way that, in a region of an insulating bushing to be inserted, two sheet metal portions are disposed at a distance from, and opposite, one another in such a way that a gap is formed between them. In this region, two bearing eyes are formed coaxially with one another in the two sheet metal portions. A reinforcing ring is inserted between the two sheet metal portions, being in coaxial alignment with the two bearing eyes. A respective die is pressed into each bearing eye. Edges of the bearing eyes are bent, and the reinforcing ring is retained by the edges of the bearing eyes.

### CROSS-REFERENCE TO RELATED APPLICATIONS

This application claims foreign priority benefits under 35 U.S.C. § 119(a)-(d) to DE Application 10 2017 215 171.4 filed Aug. 30, 2017, which is hereby incorporated by reference in its entirety.

### TECHNICAL FIELD

The disclosure relates to a vehicle control arm for a wheel suspension of a motor vehicle, and a method related thereto.

### BACKGROUND

In a case of control arms for resilient suspension of wheels of a motor vehicle, it is known to form said control arms from sheet metal that a particular three-dimensional shape is imparted by forming and cutting processes in order to produce at least a part of the control arm. As a result, in many cases, two, spaced-apart, sheet metal portions are located parallel to, and opposite one another, thus forming an elongated but slender control arm with large bearing support areas. A control arm may also be formed from two or more sheet metal parts connected to one another. These may be joined together in various ways to produce a robust component that meets demands placed on a control arm.

Such a control arm is typically connected to a body of the motor vehicle, or another component of the wheel suspension by at least one bearing bushing, which may also be referred to below as an insulating bushing. By the bearing or insulating bushing, the control arm is mounted to other components, and insulated from these other components, in order, for example, to prevent transmission of vibration between these two components. For this purpose, coaxial holes are often provided in sheet metal portions disposed opposite one another. The insulating bushing is pressed through two holes (bearing eyes). For example, JP 2004-249398 A discloses a device for pressing insulating bushing into bearing eyes of a control arm. However, depending on a design and dimensions of the control arm, this manner of fixing insulating bushing limits an integrity of an overall structure of the control arm in this region. A further possible solution consists in welding a separate bushing housing to the control arm. For example, an elastic insulating bushing consisting of a plurality of cylinders, an inner cylinder of which is configured to be elastic, is known from JP 2002-147512 A. A part of this insulating bushing is welded to a control arm.

In addition, in a field of connecting individual parts of a control arm, further design solutions are known that often relate specifically to a particular form of control arm. For example, JP 2001-259865 A describes a method for producing a control arm of a wheel suspension in which a control arm strut with a rectangular cross section is to be connected to an eye-shaped, end portion. A connection between the control arm strut and the eye-shaped, end portion is produced by friction stir welding. A bushing is inserted in the eye-shaped, end portion.

Furthermore, a V-shaped control arm with eyes to be mounted at both ends thereof is known from JP 11-241745. Here, too, eye-shaped, end portions are welded to a V-shaped control strut. Bushing are press-fitted into these eye-shaped, end portions.

U.S. Pat. No. 6,409,189 B1 discloses mounting of a control arm to a body of a motor vehicle, whereby a threaded stud is passed through an eye-shaped, end portion on the control arm. The end portion is inserted between two parallel plates of a mounting on the motor vehicle, so that it can be screwed to the mounting by a nut. For this purpose, bushing through which the threaded stud is passed are inserted in eyes of the end portions. In addition to the threaded stud, a sleeve is also passed through the bushing.

U.S. Pat. No. 5,398,411 discloses a method for producing vehicle control arms in which a material for producing the control arm is extruded and separated into individual pieces. Insulating bushing are mounted at ends of a control arm formed in this way, likewise using a stud.

Various methods are also known for connecting antiroll bars to components of a motor vehicle. For example, US 2010/0244395 A1 describes a connection by a sleeve and a rubber element.

In view of the prior art cited, the field of integrating an insulating bushing in a vehicle control arm still offers room for improvements.

### SUMMARY

It is an object of the disclosure to provide a method for producing a vehicle control arm for a wheel suspension of a motor vehicle, by which an integrity of an overall structure of the control arm is increased in a region of an insulating bushing to be inserted.

It should be pointed out that features and measures specified individually in the following description may be combined with one another in any technically appropriate manner and can represent further embodiments of the disclosure. The description additionally characterises and specifies the disclosure, in particular in conjunction with the Figures.

With a method according to the disclosure for producing a control arm for a wheel suspension of a motor vehicle, a control arm is configured in such a way from at least one sheet metal part that, in a region of a bearing bushing, or insulating bushing, to be inserted, two portions of sheet metal are disposed opposite one another at a distance such that a gap is formed between the two portions of sheet metal. In this region, two bearing eyes are formed coaxially with one another in the two sheet metal portions. For example, a vehicle control arm may have a U-shaped configuration in cross section in the region of the bearing eyes for an insulating bushing. The control arm may have a constant or variable cross section over a length of the control arm.

To produce the control arm, at least one sheet metal part is reshaped in such a way that two, spaced-apart, sheet metal portions are formed. This may be affected, for example, by forming a sheet metal element into a shell having two, lateral flanks joined by a rear section. The control arm may be substantially straight, but may also be curved. Preferably at ends of the control arm, bearing eyes into which insulating bushings can be inserted are provided in each of the sheet metal portions of the two, lateral flanks. The bearing eyes may be formed in the sheet metal before, or after, reshaping.

According to the disclosure, at least one reinforcing ring, aligned coaxially with the two bearing eyes, is inserted between the two sheet metal portions. After the reinforcing ring has been inserted, a respective die is pressed into each of the bearing eyes, whereby edges of the bearing eyes are bent in a direction of a gap to form a collar. The edges are bent in such a way that the reinforcing ring is retained via a reinforcing ring inner face by flanged edges of the bearing eyes.

In this way, a control arm that is reinforced in the region of the bearing eyes for an insulating bushing to be inserted can be produced. This is achieved by insertion of a reinforcing ring that is formed, for example, from steel. However, other materials such as fiber-reinforced plastics might be used, the edges being suitably molded and a bending process being avoided. With the reinforcing ring, a stiffness of the control arm in the region of the bearing eyes for the insulating bushing can be increased, improving the integrity of the overall structure of the control arm in the region of the bearing eyes.

Insertion of the reinforcing ring is advantageously incorporated in the manufacturing process, since the reinforcing ring is fixed at a same time as a process of bending over the edges of the bearing eyes. No additional joining steps, such as welding processes, are required. In addition, a basic design of a vehicle control arm does not need to be changed for insertion of the reinforcing ring according to the disclosure. This gives rise to an effective overall process with regard to costs and weight of the control arm. Little additional tooling is required, and there is little change to the manufacturing process for vehicle control arms.

The reinforcing ring is preferably inserted together with at least one spacer element between the two sheet metal portions, the spacer element being disposed outside the reinforcing ring. This spacer element serves, on the one hand, to maintain a distance between the two, opposed sheet metal portions as dies are pressed into the bearing eyes. Moreover, the spacer element together with the reinforcing ring is arranged in such a way that the edges of the bearing eyes are bent over at the rim edges of the reinforcing ring. An external diameter of the dies is therefore only slightly smaller than an internal diameter of the reinforcing ring. In addition, in one embodiment of the disclosure, the reinforcing ring is preferably positioned between the two sheet metal portions in such a way that reinforcing ring rim edges abut inner faces of the sheet metal parts.

The spacer element may be arranged at a distance from the reinforcing ring, although only a small clearance is appropriate. In particular, the spacer element may be in contact with an outside of the reinforcing ring, and therefore rest against the reinforcing ring from outside the reinforcing ring. In this way, the spacer element temporarily forms a two-part or multipart component with the reinforcing ring.

The spacer element may be configured in different ways. For example, the reinforcing ring may be formed by at least two, dish-shaped, spacer parts that together likewise form a kind of ring. After the edges of the bearing eyes have been bent over, the two, dish-shaped spacer parts may be removed from the gap between the two sheet metal portions, while the reinforcing ring is retained via a reinforcing ring inner face by the flanged edges of the bearing eyes. For the shaping process, the two spacer parts may be joined together and this joint may be severed after the shaping process in order to remove spacer parts.

The disclosure also includes a control arm for the wheel suspension of a motor vehicle, which control arm is formed from at least one sheet metal part in such a way that two sheet metal portions are disposed at a distance from, and opposite, one another, at least in one region, in such a way that a gap is formed between the two sheet metal portions. In this region, two bearing eyes, with edges bent in a direction of the gap to form a collar, are formed coaxially with one another in the two sheet metal portions, a reinforcing ring being arranged in the gap, which reinforcing ring is aligned coaxially with the two bearing eyes, and is retained via the reinforcing ring inner face by the flanged edges of the bearing eyes. The rim edges of the reinforcing ring preferably abut inner faces of the sheet metal portions.

A vehicle control arm reinforced in this way in the region of its bearing eyes for an insulating bushing is simple to produce, especially when utilising the method according to the disclosure with the aforementioned advantages. As compared to other vehicle control arms, the control arm has increased stiffness in the region of the bearing eyes, leading to an improvement of the integrity of the overall structure of the control arm in this region.

At least one insulating bushing extending through both bearing eyes can be inserted in the control arm. The insulating bushing is preferably pressed into the bearing eyes, which can be affected using known processes. The processes for inserting the insulating bushing do not need to be changed on account of the reinforcing ring in the control arm.

Further advantageous embodiments of the disclosure are disclosed in the following description of the Figures, in which:

### BRIEF DESCRIPTION OF THE DRAWINGS

FIG. 1 shows a three-dimensional view of an end portion of a semi-finished product that produces a vehicle control arm;

FIG. 2 shows a schematic cross section of an end portion as shown in FIG. 1;

FIG. 3 is a schematic representation of process steps in producing a vehicle control arm according to the disclosure; and

FIG. 4 shows an end portion of a vehicle control arm produced using the method according to the disclosure.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

In the various Figures, like parts are always denoted by the same reference symbols, for which these parts are generally described only once.

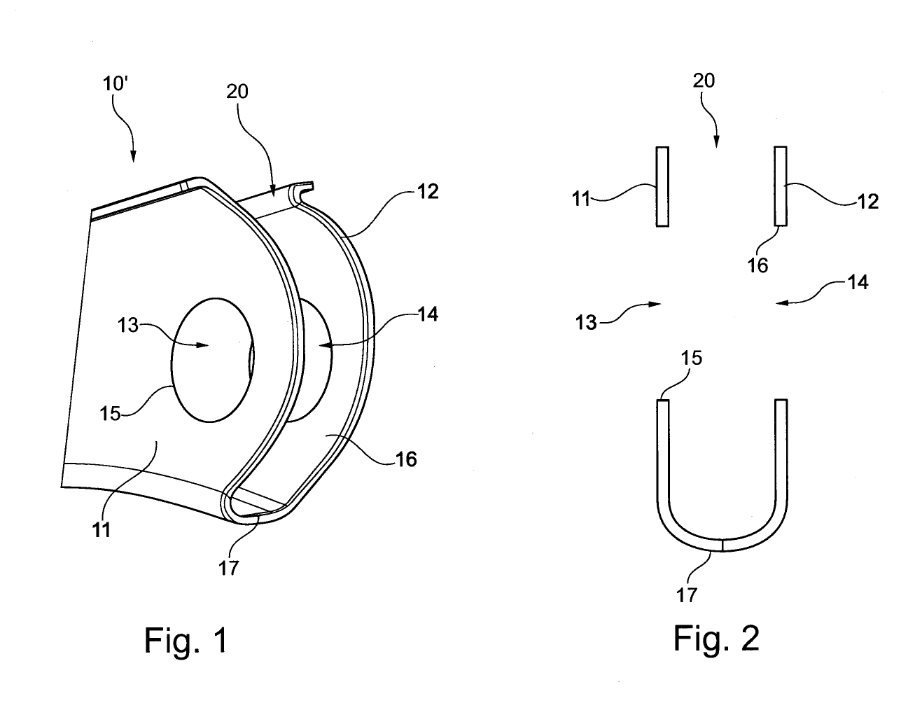

FIG. 1 shows an end portion of a semi-finished product 10′ for producing a vehicle control arm for a wheel suspension of a motor vehicle. This semi-finished product 10′ consists of at least one sheet metal part that has been given a three-dimensional form through reshaping, whereby two sheet metal portions 11 and 12 are disposed at a distance from and opposite one another. A gap 20 between the two sheet metal portions 11, 12 is thereby formed. For example, the semi-finished product 10′ may be configured to be U-shaped in cross-section, the two sheet metal portions 11, 12 forming two flanks of a U-shaped semi-finished product 10′. The two flanks are connected to one another, shown in FIG. 1 at a rear section 17. In an upper region in FIG. 1, the two sheet metal portions 11, 12 may be bent outwards. In this upper region, the two sheet metal portions 11, 12 may further be connected to one another (not shown).

At least the sheet metal portions 11, 12 and the rear section 17 of the semi-finished product 10′ may be formed in one piece from a sheet metal part. However, a multipart component may also be produced in which a plurality of sheet metal parts is joined together. FIG. 1 further shows only a first end of the semi-finished product 10′, at which a bearing bushing or insulating bushing can be inserted in bearing eyes 13, 14 of a control arm. FIG. 1 therefore shows only an attachment point for an insulating bushing relevant to the disclosure, although a plurality of such attachment points are preferably provided on the semi-finished product 10′. The remaining body of the semi-finished product 10′ may be adapted in known fashion to particular requirements of a vehicle control arm. For example, a continuation of the semi-finished product 10′ may be selected to be straight or curved.

The two bearing eyes 13, 14 are circular openings in the sheet metal portions 11, 12, which bearing eyes 13, 14 are arranged coaxially with one another. The bearing eyes 13, 14 may be formed, for example stamped or punched, before or after shaping of the sheet metal part or parts. As already mentioned, further attachment points for bearing bushings or insulating bushings may be provided on the control arm, on which attachment points bearing eyes 13, 14 coaxially formed in the two sheet metal portions 11, 12 are then likewise provided.

FIG. 2 shows such a semi-finished product 10′ in a schematic cross-section. The view in FIG. 2 shows, in particular, the two coaxially aligned bearing eyes 13 and 14, which are located opposite one another in the two sheet metal portions 11, 12.

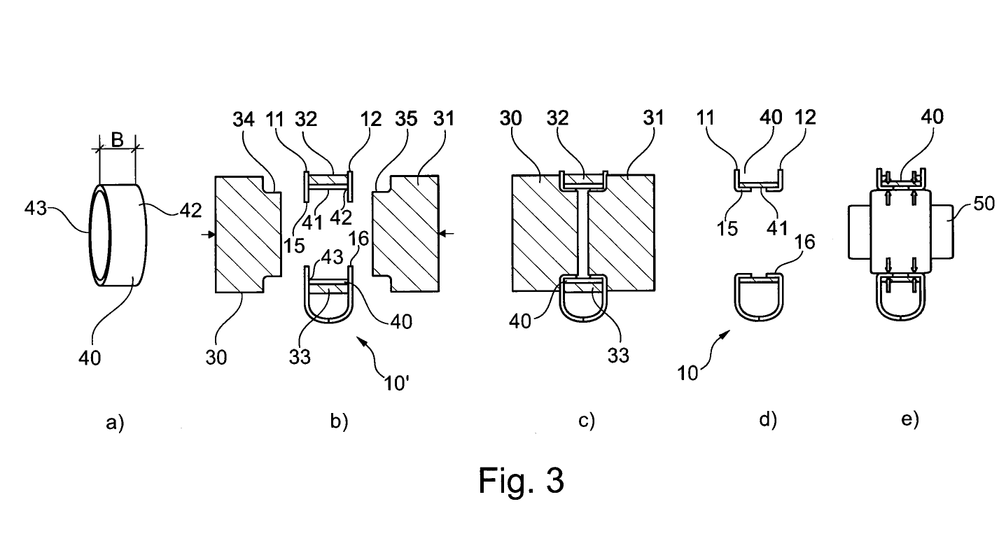

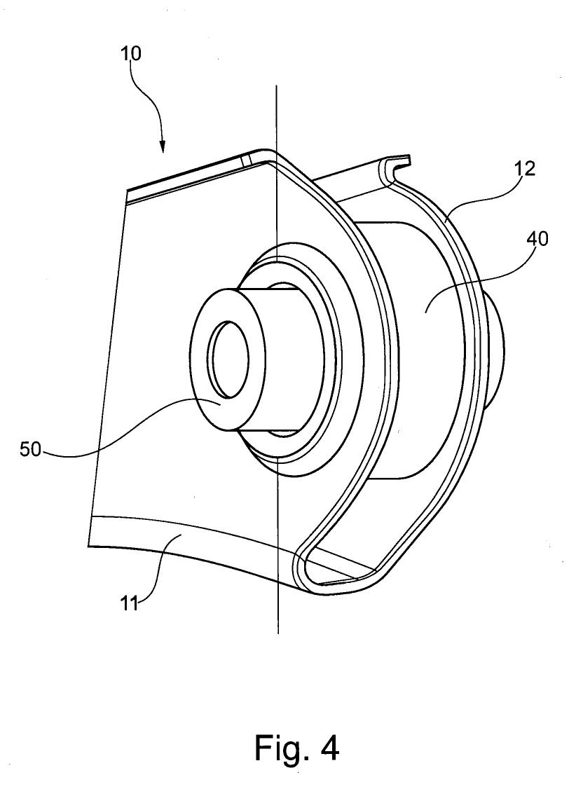

According to the disclosure, with a semi-finished product 10′ prepared in this way, a reinforcing ring 40 is inserted in a gap 20 between the two sheet metal portions 11, 12, and edges 15 and 16 of the bearing eyes 13, 14 are bent inwards in a direction of the gap 20. This process is represented in successive steps in FIG. 3. An internal diameter of a reinforcing ring 40 as shown in FIG. 3 a) is larger than a diameter of the bearing eyes 13, 14. A width B of the reinforcing ring 40 corresponds approximately to a distance between the two sheet metal portions 11, 12, although it may also be somewhat greater than this distance. The reinforcing ring 40 is preferably made of steel.

A material thickness of the reinforcing ring 40 used may, in particular, be selected as a function of a thickness of a material of the control arm in a region of the bearing eyes 13, 14. In one embodiment of the disclosure, the reinforcing ring 40 has a thickness that is at least equal to the material thickness of the sheet metal of the control arm. It may be provided that, during deformation of the bearing eyes 13, 14, the reinforcing ring 40 is also deformed, so that the reinforcing ring 40 finally abuts inner faces of the sheet metal portions 11, 12 with an exact fit. The material thickness of the reinforcing ring 40 is selected accordingly, so that as the bearing eyes 13, 14 are deformed, the reinforcing ring 40 can likewise be deformed. The thickness of the reinforcing ring is, for example, in the order of magnitude of 1-5 mm, in particular from 2-2.5 mm.

The reinforcing ring 40 is inserted in the gap 20 between the two lateral sheet metal portions 11, 12 of a semi-finished product 10′, as shown in FIG. 2, in such a way that the reinforcing ring 40 is in coaxial alignment with the two bearing eyes 13, 14. Because an internal diameter of the reinforcing ring 40 is greater than the diameter of the bearing eyes 13, 14, passage through the bearing eyes 13, 14 is free even after the reinforcing ring 40 has been inserted. This position of the reinforcing ring 40 can be seen in FIG. 3 b). Rim edges 42, 43 of the reinforcing ring 40 rest against the sheet metal portions 11, 12.

In addition, a spacer element comprising at least two spacer parts 32 and 33 is inserted between the two sheet metal portions 11, 12. These spacer parts 32, 33 may be two halves of a spacer ring that are placed from outside, against the reinforcing ring 40. In FIG. 3 b) two such spacer parts 32, 33 are shown in section. Into a combination of semi-finished product 10′, reinforcing ring 40 and spacer parts 32, 33 thus prepared, two dies 30 and 31 are pressed into the bearing eyes 13, 14 from sides. These dies 30, 31 may, as in the exemplary embodiment of FIG. 3 b), have a stepped diameter. Front pressing regions 34 and 35 of the two dies 30, 31 have a circular cross section with an external diameter that is greater than the diameter of the bearing eyes 13, 14. As the dies 30, 31 are pressed into the bearing eyes 13, 14, the edges 15 and 16 of the bearing eyes 13, 14 are therefore bent inwards in the direction of the gap 20 around the rim edges 42, 43 of the reinforcing ring 40.

An external diameter of the pressing regions 34, 35 is slightly smaller than an internal diameter of the reinforcing ring 40. The difference preferably corresponds approximately to the material thickness of the sheet metal portions 11, 12. In this way, the edges 15, 16 of the bearing eyes 13, 14 can be bent at right angles around the rim edges 42, 43 by the pressing regions 34, 35 of the dies 30, 31, in such a way that the edges 15, 16 form a kind of collar between the reinforcing ring 40 and the pressing regions 34, 35, as can be seen in FIG. 3 c).

In this pressing process, the spacer parts 32, 33 have an effect that the two sheet metal portions 11, 12 are not pressed against one another, but the edges 15, 16 of the bearing eyes 13, 14 are bent as uniformly as possible through an angle of approximately 90°. The stepped portion of the dies 30, 31 is also configured such that regions behind the pressing regions 34, 35 have a larger diameter and preferably come into abutment with outer faces of the sheet metal portions 11, 12 during the pressing process. This state of the pressing process can also be seen in FIG. 3 c).

After the edges 15, 16 of the bearing eyes 13, 14 have been bent over, the dies 30, 31 and the spacer parts 32, 33 are removed, and the vehicle control arm 10 formed by reshaping of the semi-finished product 10′ remains behind (FIG. 3 d). The reinforcing ring 40 remains in the control arm 10, being positionally secured permanently via a reinforcing ring inner face 41 by the bent-over edges 15, 16 of the bearing eyes 13, 14. The reinforcing ring 40 is preferably fixed in this position, so that the reinforcing ring is retained without free play by the collar-like edges 15, 16. In the context of this disclosure, both openings in the semi-finished product 10′ and openings with bent-over edges are referred to as bearing eyes 13, 14.

In the vehicle control arm 10 formed in this way, the bearing eyes 13, 14 and the reinforcing ring 40 now form a receptacle for a bearing bushing, or insulating bushing. The insulating bushing 50 is pressed into the two bearing eyes 13, 14, as can be seen in FIG. 3 e). In FIG. 3 e), various forces that act on the bent-over edges 15, 16 of the bearing eyes 13, 14 during operation of the vehicle control arm 10 are represented by arrows. These forces are now absorbed by the reinforcing ring 40, increasing the integrity of the overall structure of the vehicle control arm 10 in this region in comparison to similar control arms.

FIG. 4 shows a vehicle control arm 10 produced in this way with an integrated reinforcing ring 40, and pressed-in insulating bushing 50 in a three-dimensional view.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method for producing a vehicle control arm of a motor vehicle, comprising:
inserting an insulating bushing in a region between two sheet metal portions that are disposed at a distance from and opposite each other;
forming a gap between the two sheet metal portions;
forming two bearing eyes, coaxially, in the region of the two sheet metal portions;
inserting a reinforcing ring between the two sheet metal portions, being aligned coaxially with the two bearing eyes; and
pressing a die into each of the bearing eyes such that edges of the bearing eyes are bent toward the gap to form a collar, and the reinforcing ring is retained, via an inner face, by the edges of the bearing eyes.

2. The method as claimed in claim 1 further comprising inserting at least one spacer element located outside the reinforcing ring between the two sheet metal portions.

3. The method as claimed in claim 2, wherein the spacer element is formed by at least two, dish-shaped, spacer parts.

4. The method as claimed in claim 2, wherein the spacer element is in contact with the reinforcing ring, outside the reinforcing ring.

5. The method as claimed in 1, wherein the reinforcing ring is positioned between the two sheet metal parts such that rim edges abut inner faces of the sheet metal parts.

6. A vehicle wheel suspension comprising:
a control arm having two sheet metal portions in a region disposed at a distance from, and opposite one another to form a gap;
two bearing eyes coaxial with one another in the region having edges being bent toward the gap to form a collar; and
a reinforcing ring located in the gap in coaxial alignment with the two bearing eyes and retained via an inner face by the edges.

7. The vehicle wheel suspension as claimed in claim 6 further comprising an insulating bushing that extends through the two bearing eyes.

8. The vehicle wheel suspension as claimed in claim 6, wherein the reinforcement ring includes rim edges that abut inner faces of the sheet metal portions.

9. The vehicle wheel suspension as claimed in claim 6 further comprising a spacer element located outside the reinforcing ring, and inserted between the two sheet metal portions.

10. The vehicle wheel suspension as claimed in claim 9, wherein the spacer element is formed by at least two, dish-shaped, spacer parts.

11. The vehicle wheel suspension as claimed in claim 9, wherein the spacer element is in contact with the reinforcing ring, outside the reinforcing ring.

12. A vehicle suspension control arm comprising:
two sheet metal portions disposed at a distance from, and opposite one another to form a gap;
two bearing eyes coaxial with one another in a region of the two sheet metal portions having edges being bent toward the gap to form a collar; and
a reinforcing ring located in the gap in coaxial alignment with the two bearing eyes and retained via an inner face by the edges.

13. The vehicle suspension control arm as claimed in claim 12 further comprising an insulating bushing that extends through the two bearing eyes.

14. The vehicle suspension control arm as claimed in claim 12, wherein the reinforcement ring includes rim edges that abut inner faces of the sheet metal portions.

15. The vehicle suspension control arm as claimed in claim 12 further comprising a spacer element located outside the reinforcing ring, and inserted between the two sheet metal portions.

16. The vehicle suspension control arm as claimed in claim 15, wherein the spacer element is formed by at least two, dish-shaped, spacer parts.

17. The vehicle suspension control arm as claimed in claim 15, wherein the spacer element is in contact with the reinforcing ring, outside the reinforcing ring.
